(19) United States
(12) Patent Application Publication
(10) Pub. No.: US 2012/0293613 A1
(43) Pub. Date: Nov. 22, 2012

(54) SYSTEM AND METHOD FOR CAPTURING AND EDITING PANORAMIC IMAGES

(75) Inventors: Jeffrey Powers, Brown City, MI (US); Vikas Reddy, Boulder, CO (US)

(73) Assignee: OCCIPITAL, INC., Boulder, CO (US)

(21) Appl. No.: 13/474,013

(22) Filed: May 17, 2012

Related U.S. Application Data
(60) Provisional application No. 61/487,176, filed on May 17, 2011.

(51) Int. Cl. H04N 7/00; G09G 5/00; G06K 9/36

(52) U.S. Cl. 348/36; 382/282; 345/633; 348/E07.091

(57) ABSTRACT

A method of self-healing panoramic images comprises uploading image data with associated raw metadata; formatting the image data such that the raw metadata is preserved while maintaining a small file size; intelligently selecting a portion of the raw data; and reprocessing the raw metadata such that the quality of the panoramic image is improved.

### PRIORITY AND RELATED APPLICATIONS

This application claims priority to U.S. Provisional Patent Application No. 61/487,176 filed on May 17, 2011. The details of Application No. 61/487,176 are incorporated into the present application in its entirety and for all proper purposes.

### FIELD OF THE DISCLOSURE

The present invention relates generally to enabling a variety of operations to be performed on image data and metadata from a panoramic image at any point in time after a user has captured this panorama.

### BACKGROUND

Prior systems and methods do not allow the flexibility to modify or otherwise edit image and meta data in accordance with the features described below.

### SUMMARY

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

A method of self-healing panoramic images comprises uploading image data with associated raw metadata; formatting the image data such that the raw metadata is preserved while maintaining a small file size; intelligently selecting a portion of the raw data; and reprocessing the raw metadata such that the quality of the panoramic image is improved.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 is a block diagram illustrating one aspect of the invention;

FIG. 2 illustrates a flow chart showing one embodiment of a method in accordance with aspects of the present invention;

FIG. 3 is another block diagram illustrating another aspect of the invention;

FIG. 4 is yet another block diagram illustrating another aspect of the invention;

FIG. 5 illustrates additional aspects of a system constructed in accordance with aspects of the invention; and

FIG. 6 illustrates an exemplary computer structure used in connection with various aspects of the invention.

### DETAILED DESCRIPTION

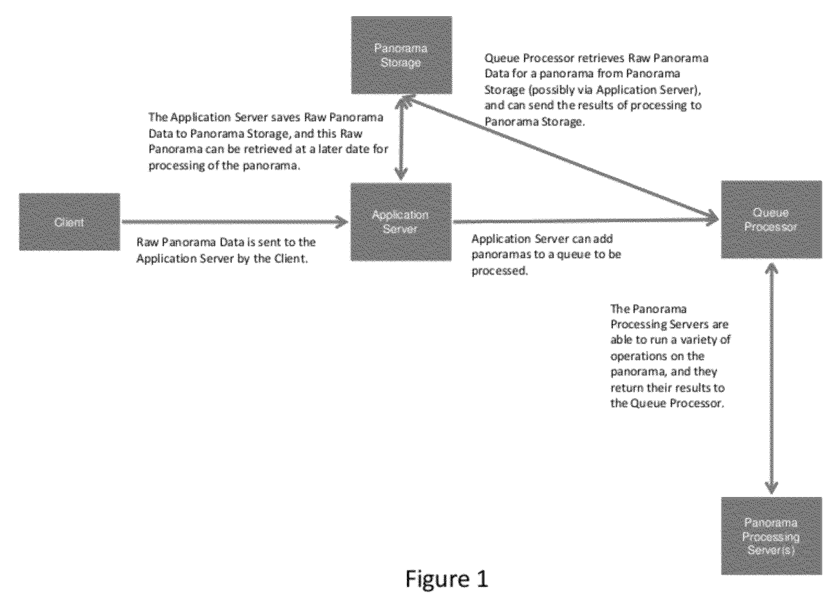

A system and method for enabling a variety of operations to be performed on image data and metadata from a panorama at any point in time after a user has captured this panorama is described below. As shown in FIG. 1, the system and method includes a panorama capture application running on a device (Client) and a Backend System comprising of: application servers which provide an API to the Client and also handle other external and internal requests (Application Server), servers responsible for processing queues of panorama processing requests (Queue Processors), servers which are able to perform a variety of operations on panoramas (Panorama Processing Server), and any data storage mechanism such as local hard-drives or remote cloud storage systems from third parties (Panorama Storage).

While a user is capturing a panorama using the Client, the Client stores individual images, in any possible image format such as JPEG or YUV, that are used to construct the panorama, along with metadata for each image containing information such as, but not limited to, an estimate of the position of the image in the panorama calculated using a variety of algorithms or reading available sensors, raw values from sensors such as gyro, accelerometer, compass, and other information about the image itself such as capture time and exposure.

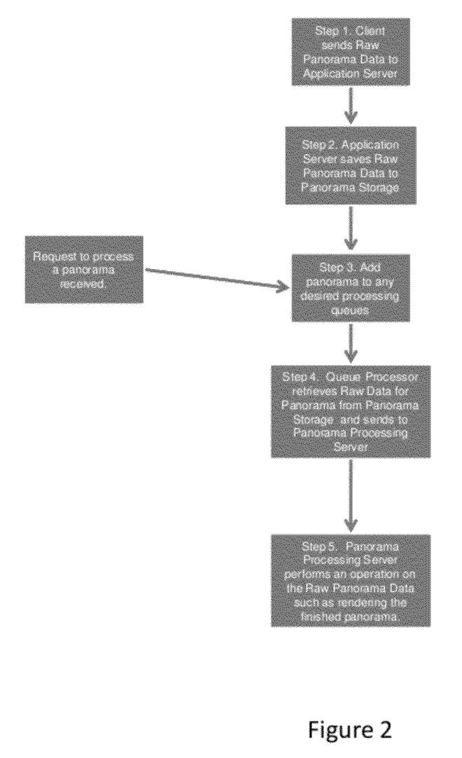

When the user is finished capturing a panorama using the Client, they are able to upload the individual images and metadata (Raw Panorama Data) to the Backend System to be processed by the Panorama Processing Servers as shown in FIG. 2.

Step 1. The Client sends Raw Panorama Data to the Application Server using any number of compressed formats for the images and metadata (e.g. JPEG for the images) and via (but not limited to) several HTTP requests.

Step 2. The Application Server saves Raw Panorama Data to Panorama Storage.

Step 3. The Application Server may, or may not add the panorama to any number of queues, each of which corresponds to a Panorama Processing Server or cluster of Panorama Processing Servers.

Step 4. Once the panorama is at the front of the queue, the Queue Processor retrieves the appropriate Raw Panorama Data from Panorama Storage (possibly via Application Server), and sends Raw Panorama Data in a request to the Panorama Processing Server.

Step 5. The Panorama Processing server performs an operation on the Raw Panorama Data, such as, but not limited to, rendering the Raw Panorama Data into a form appropriate for displaying to users in an interactive viewer, running image recognition to identity landmarks/people/objects, algorithmically computing the spatial relationship between nearby panoramas, indexing panoramas for search, etc.

Step 6. The Panorama Processing Server returns the result of its operation to the Queue Processor. Queue Processor may store the results of the operation to Panorama Storage.

The processing of a panorama can happen at any time after the Client has finished uploading Raw Panorama Data to the Backend System. For example, if the algorithms on a Panorama Processing Server are updated, all panoramas that users had finished uploading Raw Panorama Data for could be re-processed regardless of when each panorama was uploaded. In this case, only Steps 3 through 6 are necessary.

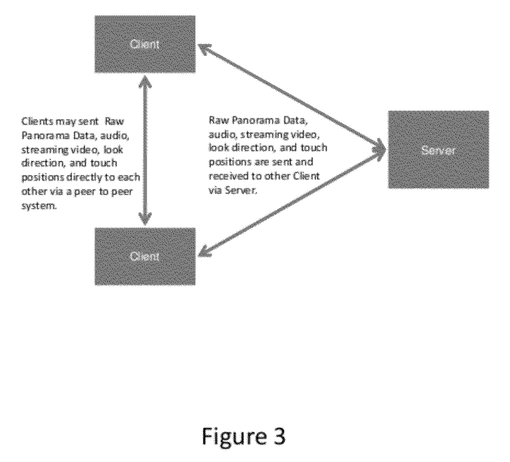

A system and method for immersive communication using panorama imagery along with audio and video is described below. As shown in FIG. 3, the system and method includes client applications with panorama capture and data streaming capabilities for mobile devices (Client), and a server used by Clients to send and receive data to other Clients and to record streaming data (Server).

A Client has two main modes—capturing mode and receiving mode. When a Client is in capturing mode, it allows the user to capture a panorama in real-time by holding their mobile phone so that the active camera points away from themselves and then moving their mobile device in a spherical orbit. The Client software makes the assumption that the user is imaging a scene that is on a sphere that is fairly far away, and then computes the user's rotation position by processing video frames from the mobile device camera using computer vision algorithms and built in sensors. This is done at close to 30 frames per second. Then, certain individual images are selected for inclusion into the panorama by the algorithm, taking into account such criteria as how far away it is from other included images, and if the user was holding still enough when the image was captured by the mobile device camera. As these individual images are selected for inclusion into the panorama, they are displayed onscreen to give feedback to the capturing Client, but they are also transmitted to a Client in receiving mode via the Server along with necessary metadata. In addition to individual images and corresponding metadata (Raw Panorama Data), look direction, voice audio, and, optionally, streaming video are all transmitted.

When a Client is in receiving mode, they transmit audio, but not video frames. They can follow the look direction of the Client in capturing mode, or unlock and freely navigate around the scene using built in device gyro or simply scrolling the screen with their fingers.

The Clients and Server use a custom protocol that is built on top of UDP. The protocol allows for both unreliable and reliable transmission of data with the goal being to minimize latency and bandwidth used since some data does not need to be reliable such as audio, while Raw Panorama Data needs to be reliable. Clients send Raw Panorama Data in compressed form such as JPEG. One custom compression that can be used is to compare an individual frame that is about to be transmitted against the frames already sent—because all images are from a panorama, there is a high likelihood of good overlap. By only sending a diff between an individual image frame and the panorama instead of the individual image frame itself, great compression can be achieved. In addition, the Server can prioritize which frames it needs to send based on its knowledge of the look direction of the Client in receiving mode.

The Client and Server have a heartbeat system where the Client checks in at certain intervals and lets the Server know that the user is still online. Users are able to maintain a buddy list through the Client and Server. Users are able to use the Client to call people on their buddy list that are using the Client and online.

The Server is able to record streaming sessions between two Clients and play it back later. The Server can also allow other receiving Clients to observe a session. These Clients may be web based instead of native mobile applications.

In both receiving and capturing modes, Clients enable users to tap the screen to create a pointer for the other Client. These pointers are sent using the same custom protocol described above.

Two Clients are able to switch modes when streaming between each other. This concept of streaming panorama imagery for immersive communication can also be extended to apply to a 3D scene. As an example, Raw Panorama Data could be replaced by Raw 3D Data which could contain individual frames containing 6 degree of freedom positions, a full translation and rotation user pose could be streamed, and the 3D structure of a scene could be transmitted.

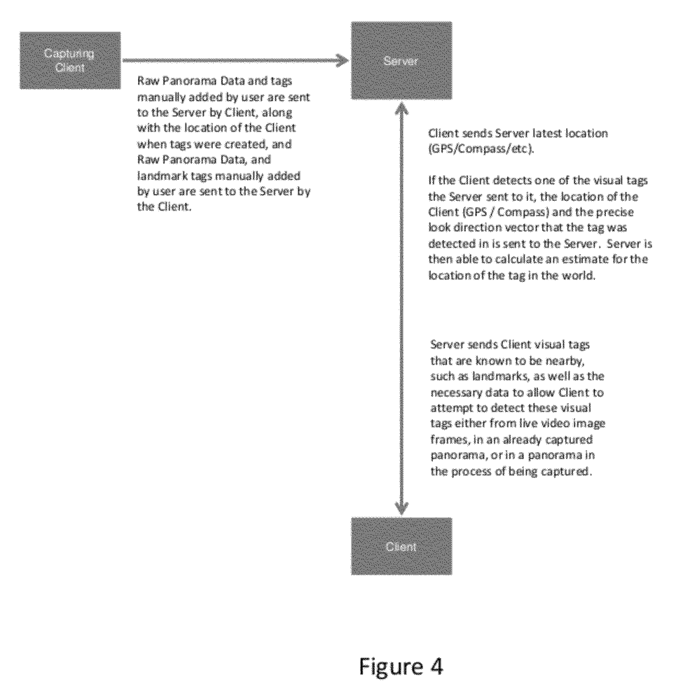

A system and method for automatic creation, displaying, and calculating accurate position using triangulation of tags for panoramas is described below. As shown in FIG. 4, the system and method includes a client application with realtime panorama capture capabilities for mobile devices (Client), and a server used to upload panorama image data along with visual tags created by users, and to send Client nearby visual tags so that Client can attempt to detect them. The Client is one of the following:

1. A real-time panorama capturing application for mobile devices that enable users to create a panorama by holding their mobile phone so that the active camera points away from themselves and then moving their mobile device in a spherical orbit. The application makes the assumption that the user is imaging a scene that is on a sphere that is fairly far away, and then computes the user's rotation position by processing video frames from the mobile device camera using computer vision algorithms and built in sensors. This is done at close to 30 frames per second. Then, certain individual images are selected for inclusion into the panorama by the algorithm, taking into account such criteria as how far away it is from other included images, and if the user was holding still enough when the image was captured by the mobile device camera. As these individual images are selected for inclusion into the panorama, they are displayed onscreen to give feedback to the user.

2. An Augmented Reality application that overlays landmark and other tags visually on top of a camera feed on a mobile device.

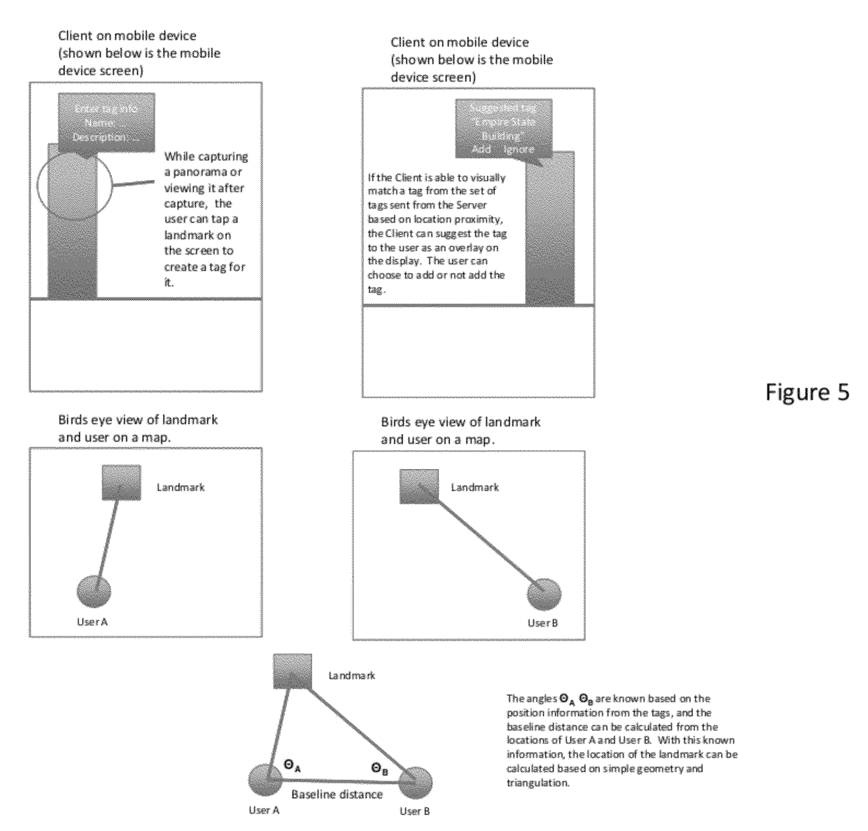

As shown in FIG. 5, a user can tap the screen while they are capturing or finished capturing a panorama to create a visual tag. For example, they could tap a building or other landmark that is in view and create a tag with name, description, or other relevant information. The exact look vector along which the tag was created is recorded, relative to the compass reading and location (GPS) for the panorama. Then the user can upload the panorama image data and tags up to the Server.

Then, a different user can launch a Client, and either while exploring a scene in Augmented Reality view or while capturing a panorama, the Client can send a request to the Server including the location (GPS, compass) of the Client. The Server can then send back visual tags that it knows are nearby in location, along with a small amount of visual data or extracted image features that can be used by the Client to attempt to visually detect these tags in its own panorama or view.

If the Client detects a visual match with a tag, it can suggest this tag to the user by overlaying it on the device display in the appropriate location (also shown in FIG. 3). The user can either add, ignore, or reject the tag.

If the user adds the tag, then the location of the visual tag (e.g. landmark) in the world can be calculated using triangulation (as shown in FIG. 5). All the information required for triangulation is known—the location of the two users (thus we know the distance between them), and both of their precise angles to the visual tag.

The Server can also compute the location of certain tags by taking two panorama that were taken fairly close vantage points, but still have some distance between them, and then use the images from the two panoramas to do a 3D reconstruction of the scene using techniques from the field of computer vision and taking advantage of multiple view geometry. Once a 3D model is created from the two panoramas, the depth to each tag in each panorama is known, and so it is straightforward to compute the location of a visual tag.

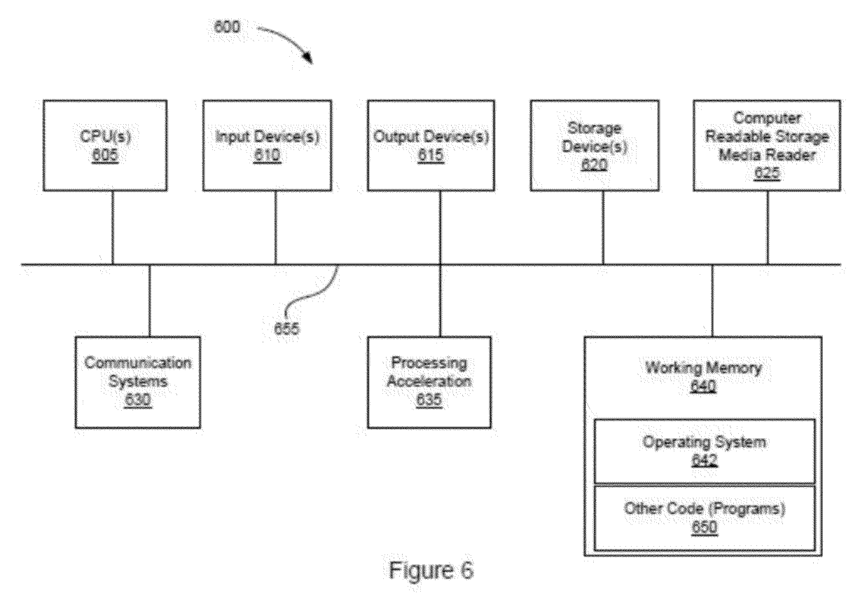

FIG. 6 illustrates a machine such as a computer system in which the systems and methods herein disclosed can be implemented. The systems and methods described herein can be implemented in a machine such as a computer system in addition to the specific physical devices described herein. FIG. 6 shows a diagrammatic representation of one embodiment of a machine in the exemplary form of a computer system 600 within which a set of instructions for causing a device to perform any one or more of the aspects and/or methodologies of the present disclosure to be executed. Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Memory 610 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof.

Computer system 600 may also include a storage device 630. Examples of a storage device (e.g., storage device 630) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 may be removably interfaced with computer system 600 (e.g., via an external port connector (not shown)). Particularly, storage device 630 and an associated machine-readable medium 635 may provide nonvolatile and/or volatile storage of machine-readable instructions, data structures, program modules, and/or other data for computer system 600. In one example, software 625 may reside, completely or partially, within machine-readable medium 635. In another example, software 625 may reside, completely or partially, within processor 605. Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch screen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof.

A user may also input commands and/or other information to computer system 600 via storage device 630 (e.g., a removable disk drive, a flash drive, etc.) and/or a network interface device 645. A network interface device, such as network interface device 645 may be utilized for connecting computer system 600 to one or more of a variety of networks, such as network 650, and one or more remote devices 655 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 650, may employ a wired and/or a wireless mode of communication. In general, any network topology may be used. Information (e.g., data, software 625, etc.) may be communicated to and/or from computer system 600 via network interface device 645.

Computer system 600 may further include a video display adapter 660 for communicating a displayable image to a display device, such as display device 665. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof. In one example an audio device may provide audio related to data of computer system 600 (e.g., data representing an indicator related to pollution impact and/or pollution offset attributable to a consumer).

In conclusion, the present invention provides, among other things, a method, system, and apparatus that enables real-time predictions of electrical power output from wind turbines via use of remotely-located wind speed sensors. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A system for self-healing panoramic images, comprising:
a processor adapted to perform a method comprising,
uploading image data with associated raw metadata;
formatting the image data such that the raw metadata is preserved while maintaining a small file size;
intelligently selecting a portion of the raw data; and
reprocessing the raw metadata such that the quality of the panoramic image is improved.

2. A method for immersive communication using panoramic imagery created in real-time, comprising:
allowing a user to capture an immersive view of the imagery being created in real-time;
transmitting the imagery to a viewer at a remote location;
determining an intelligent format to send data between the user and viewer;
optimizing the data for a low bandwidth connection;
determining whether to send a full or partial frame of the imagery based on which part of field of view has not been transmitted before;
uploading feature trails of the imagery and/or feature descriptors for every frame of the imagery that is transmitted;
allowing the user to control which part of the imagery the remote user is viewing; and
allowing either the user or viewer to point to a display visual overlays.

3. A method for the display, auto tagging, and triangulation of tags for panoramas comprising:
proposing object tags that are nearby and detected to be in view;
triangulating the location of the object that is tagged;
identifying the tag; and
overlaying the tags in an augmented reality scheme.
